(19) United States
(12) Patent Application Publication
(10) Pub. No.: US 2005/0002412 A1
(43) Pub. Date: Jan. 6, 2005

(54) Method and system of retransmission

(76) Inventors: Mats Sagfors, Kyrkslatt (FI); Janne Peisa, Espoo (FI); Michael Meyer, Aachen (DE); Reiner Ludwig, Huertgenwald (DE)

Correspondence Address: ERICSSON INC., 6300 LEGACY DRIVE, M/S EVR C11, PLANO, TX, 75024, US

(21) Appl. No.: 10/495,602

(22) PCT Filed: Nov. 15, 2002
(86) PCT No.: PCT/SE02/02088

(30) Foreign Application Priority Data
Nov. 15, 2001 (SE) 0103853-8

(51) Int. Cl. H04J 3/16

(52) U.S. Cl. 370/437

(57) ABSTRACT

The present invention relates to a method and system of transmissions and retransmissions of packet data in a communications system, where the communications system uses switched channels, switching between rates or channels of different characteristics, and connection control and management in such a system. Particularly, the invention relates to radio resource management in a Universal Mobile Telecommunications System, UMTS, or WCDMA system allowing for use of compatible protocols for non-switched and switched channels.

### TECHNICAL FIELD OF THE INVENTION

The present invention relates to transmissions and retransmissions of packet data in a communications system, where the communications system uses rate switching or channel switching. Especially, it relates to transmissions of packet data in a cellular mobile radio system, particularly a Universal Mobile Telecommunications System, UMTS, or WCDMA system.

### BACKGROUND AND DESCRIPTION OF RELATED ART

Retransmission of data to or from a mobile station, MS, or user equipment, UE, is previously known. It is also known to use medium access control and radio link control layers of a UMTS protocol structure in acknowledged mode for dedicated channels and to transmit packet data using use protocols, such as TCP (Transmission Control Protocol), that controls the transmission rate, based on link quality in terms of packet loss and delay characteristics.

In acknowledged mode of UMTS, retransmissions are undertaken in case of detected transmission errors not recovered by forward error control. This is also called automatic repeat request, ARQ. With ARQ, retransmissions can be undertaken unless a transmitted message is (positively) acknowledged within a predetermined time frame, or if it is negatively acknowledged.

Within this patent application, a radio network controller, RNC, is understood as a network element including a radio resource controller. The RNC is connected to a fixed network. Node B is a logical node responsible for radio transmission/reception in one or more cells to/from a User Equipment. A base station, BS, is a physical entity representing Node B. A server device provides information accessible to other devices over a communications network such as, e.g., the Internet. A client device is a device having access to information provided by one or more devices over a communications network.

With reference to FIG. 1, base stations <<BS 1>> and <<BS 2>> are physical entities representing Nodes B <<Node B 1>> and <<Node B 2>> respectively. <<Node B 1>> and <<Node B 2>> terminate the air interface, called Uu interface within UMTS, between UE and respective Node B towards the radio network controller <<RNC>>. <<RNC>> is connected to a fixed network <<Network>>. The fixed network may comprise one or more Server Devices <<Server Device>>.

Medium access control, MAC, and radio link control, RLC, is used within radio communications systems like General Packet Radio Services, GPRS, and UMTS.

The Internet Society: Request for Comments (RFC) No. 3135, June 2001 describes proxy solutions for some explicitly mentioned systems, including systems operating with TCP for communication links being subject to small bandwidth-delay products, such as W-LANs (Wireless Local Area Networks), W-WANs (Wireless Wide Area Networks) and GSM (Global System for Mobile Communications) or links optimized with small block error rates (BLER), such as satellite links.

The Internet Society: Request for Comments (RFC) No. 2488, January 1999 and RFC No. 3135 describe some characteristics of a satellite channel,
1. propagation delays in the range of 480 ms to a few seconds,
2. data rates in the range of a few kilobits per second to multiple megabits per second,
3. asymmetric ratio of IP packet bytes for data and acknowledgements respectively and
4. very low bit error rates during clear sky conditions.

As severe weather conditions are rare, satellite links are generally optimized for clear sky conditions with very low bit error rates and (for moderate block sizes) small block error rates, in accordance with characteristic No. 4.

The Internet Society: Request for Comments (RFC) No. 2581, April 1999 describes four phases of TCP load adaptation:
1. Slow Start,
2. Congestion Avoidance,
3. Fast Retransmit and
4. Fast Recovery.

Slow Start slowly probes the network to determine the available capacity in order to avoid congestion. Slow Start is used when beginning transmission or after repairing detected lost packets. For the purpose of Slow Start TCP makes use of two variables, cwnd (congestion window) and rwnd (receivers advertised window). cwnd is a sender-side limit of the number of data packets outstanding and rwnd is a receiver-side limit on window size. A third variable ssthresh (Slow Start threshold) determines whether Slow Start or Congestion Avoidance will be used for congestion control. Slow Start is used when cwnd<ssthresh and Congestion Avoidance is used when cwnd>ssthresh. When cwnd=ssthresh either Slow Start or Congestion Avoidance can be used.

At the beginning of a data transfer Slow Start is used to probe the network for its conditions. For each (positively) acknowledged data packet, the sender-side increases cwnd until it reaches ssthresh.

During Congestion Avoidance cwnd is increased in relation to round-trip time until a packet loss is detected, which is interpreted as congestion. This is e.g. the case if a retransmission timer times out without a packet being acknowledged during the retransmission time of the packet.

When the receiver-side receives an out-of-order packet it sends a duplicate ACK, indicating which sequence number it expects. After receiving three consecutive duplicate ACKs indicating the same sequence number, TCP retransmits the indicated segment without waiting for the retransmission: timer to time out. This is Fast Retransmit. Subsequent transmissions are sent during Fast Recovery until a non-duplicate ACK is received. During Fast Retransmit and Fast Recovery cwnd and ssthresh are adjusted.

U.S. Patent Application US5673322 describes a split proxy system that encapsulates TCP/IP transmissions into a script transmission.

European Patent Application EP1109359 describes an apparatus and method for dividing a TCP connection into two connections, having congestion control in only one of the two connections.

International Patent Application WO0021231 relates to a system for communicating data packets over a packet switched network where a buffering network entity acts as end-receiver of data packets transmitted from a sending host.

European Patent Application EP0991242 describes a method and apparatus for caching credentials in proxy servers for wireless user agents.

3^{rd} Generation Partnership Project (3GPP): Technical Specification Group Radio Access Network, Radio Interface Protocol Architecture, 3GPP TS 25.301 v3.6.0, France, September 2000, describes an overall protocol structure of a Universal Mobile Telecommunications System (UMTS). There are three protocol layers:
physical layer, layer 1 or L1,
data link layer, layer 2 or L2, and
network layer, layer 3 or L3.

Layer 2, L2, and layer 3, L3 are divided into Control and User Planes. Layer 2 consists of two sub-layers, RLC and MAC, for the Control Plane and four sub-layers, BMC, PDCP, RLC and MAC, for the User Plane. The acronyms BMC, PDCP, RLC and MAC denote Broadcast/Multicast Control, Packet Data Convergence Protocol, Radio Link Control and Medium Access Control respectively.

FIG. 2 displays a simplified UMTS layers 1 and 2 protocol structure for a Uu Stratum, UuS, or Radio Stratum, between a user equipment UE and a Universal Terrestrial Radio Access Network, UTRAN.

Radio Access Bearers, RABs, are associated with the application for transportation of services between core network, CN, and user equipment, UE, through a radio access network. Each RAB is associated with quality attributes such as service class, guaranteed bit rate, transfer delay, residual BER, and traffic handling priority. An RAB may be assigned one or more Radio Bearers, RBs, being responsible for the transportation between UTRAN and UE. For each mobile station there may be one or several RBs representing a radio link comprising one or more channels between UE and UTRAN. Data flows (in the form of segments) of the RBs are passed to respective Radio Link Control, RLC, entities which amongst other tasks buffer the received data segments. There is one RLC entity for each RB. In the RLC layer, RBs are mapped onto respective logical channels. A Medium Access Control, MAC, entity receives data transmitted in the logical channels and further maps logical channels onto a set of transport channels. In accordance with subsection 5.3.1.2 of the 3GPP technical specification MAC should support service multiplexing e.g. for RLC services to be mapped on the same transport channel. In this case identification of multiplexing is contained in the MAC protocol control information.

Transport channels are finally mapped to a single physical channel which has a total bandwidth allocated to it by the network. In frequency division duplex mode, a physical channel is defined by code, frequency and, in the uplink, relative phase (I/Q). In time division duplex mode a physical channel is defined by code, frequency, and time-slot. As further described in subsection 5.2.2 of the 3GPP technical specification the L1 layer is responsible for error detection on transport channels and indication to higher layer, FEC encoding/decoding and interleaving/deinterleaving of transport channels.

PDCP provides mapping between Network PDUs (Protocol Data Units) of a network protocol, e.g. the Internet protocol, to an RLC entity. PDCP compresses and decompresses redundant Network PDU control information (header compression and decompression). 3^{rd} Generation Partnership Project (3GPP): Technical Specification Group Radio Access Network, RLC Protocol Specification, 3GPP TS 25.322 v3.5.0, France, December 2000, specifies the RLC protocol. The RLC layer provides three services to higher layers:
transparent data transfer service,
unacknowledged data transfer service, and
acknowledged data transfer service.

In subsection 4.2.1.3 an acknowledged mode entity, AM-entity, is described (see FIG. 4.4 of the 3GPP Technical Specification). In acknowledged mode automatic repeat request, ARQ, is used. The RLC sub-layer provides ARQ functionality closely coupled with the radio transmission technique used. 3^{rd} Generation Partnership Project (3GPP): Technical Specification Group Radio Access Network, Architectural Requirements for Release 1999, 3GPP TS 23.121 v3.5.1, France, December 2000, specifies adopted solutions for data retrieve at GPRS-UMTS handover and data retrieve in UMTS.

FIG. 3 shows protocol architecture for IP domain user plane. The radio interface, Uu, and L1, L2/RLC and L2/MAC protocol layers of UE and UTRAN have been described in relation to FIG. 2. UTRAN communicates over an Iu interface with a Core Network. TCP/IP, UDP/IP, AAL5 and ATM are protocols or protocol layers well known to a person skilled in the art. TCP/IP or UDP/IP transfers data depending on network type and/or application. Multimedia C-plane and U-plane are run transparently over a PDP-context between the UE and multimedia gatekeeper and gateway in Core Network. A GPRS Tunneling Protocol, GTP, runs on top of TCP/IP or UDP/IP. GTP-u stands for GTP User Plane Protocol. The User Plane in a UMTS network is made up of two logical connections or tunnels, a first tunnel on the Iu interface, between RNC and SGSN (Serving GPRS Support Node), and a second tunnel on a Gn interface, between SGSN and GGSN (Gateway GPRS Support Node), not illustrated in FIG. 3. Data packets are transferred through the tunnels specifying (possibly dynamically assigned) an IP address for each user. GTP specifies a protocol for tunnel control and management. Signaling is used to create, modify or delete tunnels. ATM based protocols, <<AAL5>>, <<ATM>> can be used below IP. As an alternative, Ethernet based protocols can be used.

Higher layer applications can be, e.g., applications on the Internet. Most applications on the Internet use protocols, such as TCP (Transmission Control Protocol), that control the transmission rate, based on link quality in terms of packet loss and delay characteristics. Consequently, besides the negative effect of retransmission delays as such on perceived quality, substantial queuing delay can also lead to secondary effects further reducing quality of service.

None of the cited documents above discloses a method and system of transmissions and retransmissions of packet data in systems using rate switching or channel switching allowing for compatible protocols for fixed and switched rates/channels, or provide an interface to channel resource management.

### SUMMARY OF THE INVENTION

In a system according to prior art buffering of data in a Radio Network Controller causes delay and round-trip time latency. I.e. the time for a user or user application to perceive a response to transmitted data or undertaken action from the receiving end is not immediate. Further buffering causes delay of (one-way) data destined for a user equipment. Protocols used for transmission, e.g. and by way of predominant example TCP (Transmission Control Protocol), use congestion algorithms that will utilize channel resources of a channel switching system inefficiently if not properly managing channel resources.

A prior art radio link control protocol, e.g., includes retransmission protocols that can cause protocols, such as TCP, at a higher application layer to behave as if the channel were congested, when the reasons is not congestion or channel overload, but a designed channel characteristic due to radio resource management.

For high-speed data transmissions over link protocols with relatively small buffer sizes, evaluation of the need for capacity of existing connections and allocation of capacity to new connections are difficult or impossible.

Consequently, it is an object of this invention to increase utilization of channel resources of a channel switching system.

It is also an object of this invention to eliminate or reduce delay and latency as perceived by a user.

A related object is to reduce delay and latency as perceived by a congestion control algorithm with applications such as Internet connections over a radio link in a WCDMA (Wideband Code Division Multiple Access) system.

A further object is to enable or simplify allocation and management of capacity to new and existing connections, including evaluation and prediction of capacity needs for various connections.

Finally, it is an object to integrate radio resource management of a channel switching radio communications system and a proxy server.

These objects are met by the invention, which is particularly well suited for a Universal Mobile Telecommunications System, UMTS, providing an interface between a proxy and channel resource management, particularly radio resource management.

Preferred embodiments of the invention, by way of examples, are described with reference to the accompanying drawings below.

### BRIEF DESCRIPTION OF THE DRAWINGS

FIG. 1 shows communication between a UE and a base station involved in a connection between an RNC and the UE.

FIG. 2 displays a layered protocol structure, according to prior art, in a radio communications system.

FIG. 3 shows protocol architecture for IP domain user plane, according to prior art.

FIG. 4 displays radio resource control, according to prior art.

FIG. 5 displays a first embodiment for radio resource control, according to the invention.

FIG. 6 displays a second embodiment for radio resource control, according to the invention.

FIG. 7 shows a stand alone performance enhancing proxy, according to the invention.

FIG. 8 illustrates a performance enhancing proxy integrated with RNC, according to the invention.

FIG. 9 shows a block diagram with a stand alone performance enhancing proxy <<PEP>> connected to a User Equipment <<UE>>, according to the invention.

FIG. 10 illustrates an exemplary performance enhancing proxy <<PEP>> integrated with a User Equipment <<UE>>, according to the invention.

### DESCRIPTION OF PREFERRED EMBODIMENTS

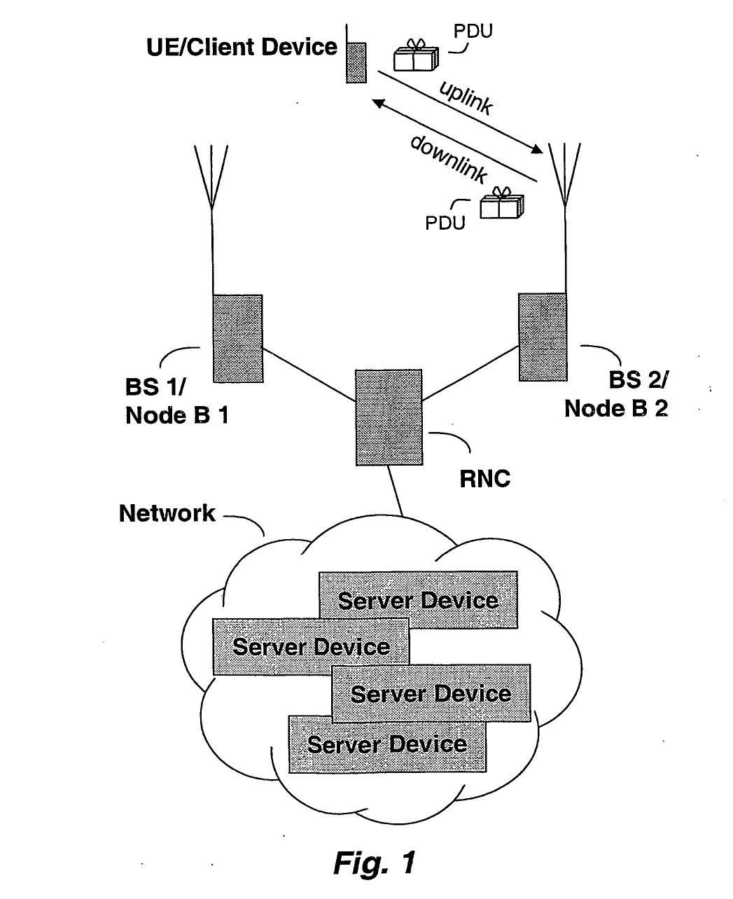

FIG. 4 displays radio resource control, according to prior art. A <<Packet Data Server>>, e.g. a Web Server corresponding to <<Server Device>> of FIG. 1, transmitting data packets to a User Equipment <<UE>>, being client device, using a packet data protocol including congestion control, such as TCP.

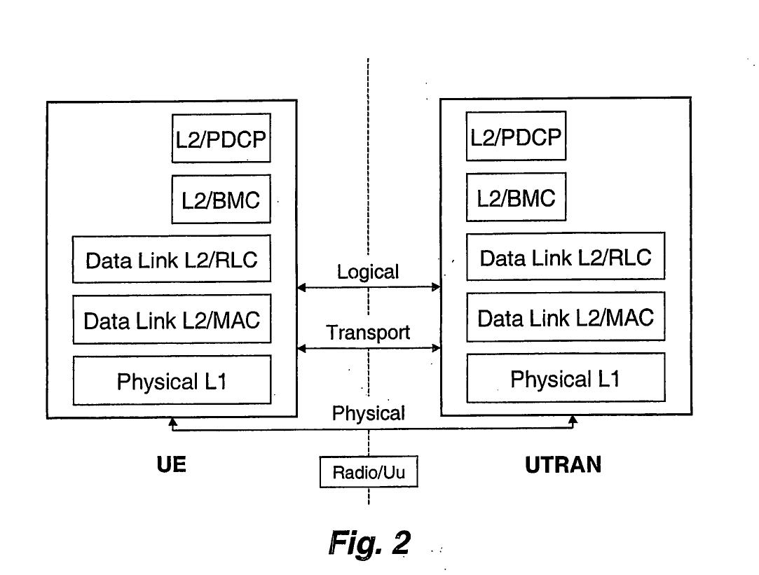

Data packets <<Packet 1>>, <<Packet 2>>, <<Packet 3>>, <<Packet 4>> are transmitted from the Packet Data Sender through a network to a Radio Network Controller. In accordance with UTRAN technical specifications, RNC includes an RLC protocol layer, as schematically illustrated in FIG. 2. <<RNC>> communicates with User Equipment <<UE 1>>, <<UE 2>>. The RNC comprises Radio Resource Management <<RRM>> undertaking Radio Resource Control, assigning and switching channel resources. According to prior art RRC relies on local traffic measurements in <<RNC>> and there are no means for distinguishing the different traffic or data dependent needs for channel resources of the different connections of the RNC. There is a sender-receiver relationship between <<RNC>> and <<UE 1>> and <<UE 2>>, respectively. Packets transmitted from RLC protocol entity residing in RNC are acknowledged by User Equipment <<UE 1>>, <<UE 2>>. The sender-receiver relationship is subject to latency due to a round-trip delay between RNC and UE, not illustrated to simplify reading. Assuming that <<UE 1>> and <UE 2>> are using an application making use of e g. TCP, such as web browsing, the Packet Data Sender transmits TCP packets to be acknowledged by the respective client devices <<UE 1>>, <<UE 2>>. To avoid confusion, “application protocol acknowledgements” refer to acknowledgements associated with the L3 network layer and “RLC acknowledgements” refer to acknowledgements associated with the L2/RLC protocol layer. As the application protocol acknowledgements and the RLC acknowledgements are nested, the application protocol acknowledgments will perceive an increasing round-trip time delay as the RLC acknowledgements round-trip time increases.

A problem inherent in interconnected links, such as interconnection of a fixed wireline Internet communications link and a switched wireless communications link, is the different respective characteristics of the communication links, and the congestion control, such as that of TCP for Internet connections, of communications on the interconnected links. A major problem of TCP, when used over links of different characteristics, is the congestion control back-off, particularly when entering Slow Start state, due to the congestion control algorithm perceiving or misinterpreting a channel as being congested, when the perceived behavior is due to different link characteristics of various parts of an end-to-end connection. This is particularly the case, when interconnecting fixed wireline links and switched wireless links with great bandwidth-delay product. Such misinterpretation will cause an overall end-to-end link to underperform.

Of course, it is possible for a Packet Data Sender to use a transport protocol designed particularly for a channel switching communication system such as UMTS. However, it is a great advantage if the same application protocols at network layer, and advantageously even lower level protocols of the network layer, could be used for clients and servers irrespective of whether a user accesses the server over a fixed network connection or a channel switching communications system. This invention allows for use of compatible protocols in wireline and wireless systems, at least for an application layer in L3 network layer, and advantageously also for use of compatible lower level protocols, such as lower level protocols used on the Internet. Prior art, as referred to above, provide low performance or is restricted to usage of dedicated protocols for toll-quality performance. The invention provides a high-performance solution to the deficiencies of prior art, as described.

An aspect of the invention is that according to prior art RLC buffers risk to run out of data, even if there is data to transfer from a data provider to a user in e.g. UMTS. This will lead to radio resources being underutilized and users experiencing increased latencies and delays or even the connection to be broken. There is also a risk of the transfer from the data provider to stall.

In UMTS, existing RLC protocols operate with limited buffer sizes. One reason for this is delay constraints. According to prior art data throughput and buffer status measurements provide very limited information on the future bandwidth needs of a connection. Buffer fill level and data throughput measurements provide no means to distinguish whether the packets presently loading the link are the last few of a transfer, or if there remains a lot of data at the sender still to be transmitted. Consequently, evaluation of data-related need for capacity of existing connections and allocation of capacity to new connections are difficult or impossible. There is no information in RLC buffer on how large objects a client is retrieving from the Packet Data Sender, e.g. downloading, to estimate a user's near-future need, associated with the data he is retrieving, for channel capacity.

As a non-exclusive example illustrating a problem of prior art, RRM may perform a channel up-switch, allocating more channel capacity to a connection, at a moment when the last bits of a data transfer have been transmitted leading to waste of channel resource of no value to the user obtaining data bandwidth increase, reducing the data bandwidth available to other connections of a scarce shared channel resource.

The problem cannot be solved by increasing RLC buffer size, as long as the RLC buffer is part of an end-to-end-delay of a connection between a data provider and an end user, where the data provider awaits application protocol acknowledgements from the user, since increasing RLC buffer size would introduce additional delay and require extensive time-out limits.

Another problem in prior art is evaluation when there is a plurality of on-going connections. It is difficult or impossible for the channel resource management, such as RRM (‘radio resource management’) in UMTS, to evaluate which connection or connections of a plurality of active ones that is in need for more capacity or bandwidth.

A problem related to a transport protocol such as TCP and channel switching is that sudden buffer drainage in RLC buffer, or corresponding prior art buffer, or low throughput due to, e.g., TCP loss recovery or great variations in packet delays may trigger unwanted channel down-switch, if, e.g., channel resource management interprets data transmissions to have ended, notwithstanding a lot of data remain to be sent from the data provider. A straightforward solution to avoid channel down-switching is to have extensive prohibit time delays prohibiting channel down-switching during a predefined time frame beginning at the first instance of indication of a broken connection or a connection with less need for capacity. However, such a solution would be inefficient in a channel resource perspective, prohibiting other connections to access channel resources of truly broken connections during the prohibit time frame, leaving scarce channel resources underutilized.

The present invention provides a solution also to this problem. Interfacing the data provider and acknowledging correctly received packets in close relation to channel resource management, such as RRM in UMTS, enables the data provider to proceed data transmissions. This will prevent data transmissions from getting stalled due to RLC or corresponding buffer running out of data due to end-to-end-latency between data provider and end user, or reduce the risk thereof. As already mentioned, it will also allow for improved prediction of channel capacity to allocate. Consequently, prohibit time frames for channel down-switching can be reduced or eliminated, increasing utilization of scarce channel resources, such as radio channel resources.

The present invention provides for efficient channel switching and good radio resource utilization of particularly a UMTS system, but also applies to other systems using packet services such as GPRS, enabling reliable predictions of future bandwidth needs of connections close to radio resource management, generally located in RNC.

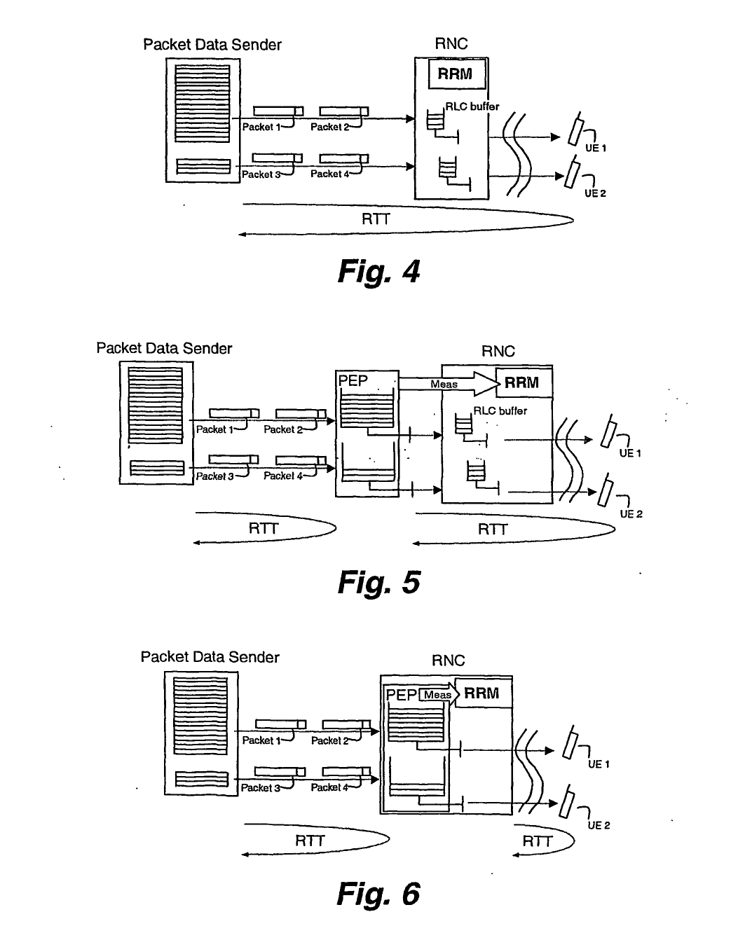

FIG. 5 displays a first embodiment for radio resource control, according to the invention. The embodiment introduces a Performance Enhancing Proxy <<PEP>> between <<Packet Data Sender>> and Client Device/User Equipment <<UE 1>>, <<UE 2>>. <<PEP>> comprises buffers of sizes sufficiently large to store objects of data, in their entirety or in part, to be transmitted to the client. <<PEP>> further splits the application protocol connection between <<Packet Data Sender>> and client <<UE 1>>, <<UE 2>> into two parts. One part being between <<Packet Data Sender>> and <<PEP>>, the other being between the proxy <<PEP>> and user equipment <<UE 1>>, <<UE 2>>. Now only application protocol acknowledgements between <<PEP>> and <<UE 1>> or <<UE 2 >> are nested with RLC acknowledgements; application protocol acknowledgement between <<Packet Data Sender>> and <<PEP>> are not. Thus congestion control of data provider <<Packet Data Sender>> and <<PEP>> will be unaffected of radio resource management considerations in <<RNC>>. Sender-side and receiver-side window sizes cwnd, rwnd, and other parameters used for congestion control of e.g. TCP can be adjusted individually for each part of the TCP-connection and need not be identical. This is one reason for which capacity is increased according to the invention as compared to prior art. Another reason is that channel resources can be more heavily utilized, increasing their block error rates the block errors to be recovered by retransmissions, during heavy-traffic hours to increase system throughput.

According to the invention, a particular advantage is achieved by the introduction of a proxy <<PEP>> if its buffer size is optionally selected large enough to comprise typical sizes of entire data objects from <<Packet Data Sender>>. The buffer content can then be made use of to predict the need for channel resources to transmit the data packets of the entire objects. However, also optionally partly stored objects provide information for prediction. Therefore, RRC based upon measurement data from <<PEP>> can be made more reliable than if RRC would need to rely on estimates based solely upon data in RLC buffers, according to prior art. Such prior art information comprises statistics on times in buffer, such as average time in buffer or buffering time for last transmitted packet, not related to the data objects.

A further advantage of introducing <<PEP>> is that the needs of individual users/clients can be predicted in contrast to prior art solution depicted in FIG. 4.

FIG. 6 displays a second embodiment for radio resource control, according to the invention. The RLC protocol layer buffers data packets not yet acknowledged. FIGS. 4 and 5 are illustrated to comprise dedicated RLC buffers for this purpose. If PEP is integrated with <<RNC>> or the RLC entity, buffer space can be reduced by sharing buffer space between <<PEP>> and RLC entity.

The Transmission Control Protocol, used as an example in the explanations above, is sensitive to large channel band-width-delay products and non-negligible block error rates. In UMTS systems channel error rate is traded with delay. High physical error rates can be reduced by the use of ARQ between <<RNC>> and User Equipment <<UE 1>>, <<UE 2>> at the cost of delay. Compared to, e.g., second generation (or earlier) mobile radio communications systems such as GSM and IS-95, WCDMA systems offer large bandwidths.

Channels can be switched for several reasons. One example of channel switching is handover from one base station to another as a user moves. Another reason can be some channels being subject to heavy interference whereas others are not. By use of different channelization codes in WCDMA, users are allocated channels of different data rates. Other wireless systems, such as W-LANs (Wireless Local Area Networks) generally do not provide for handover from one base station to another including channel switching even if they allow for quasi-stationary connections to different base stations of the systems.

As a user moves with his user equipment away from a base station <<BS 1>> towards another base station <<BS 2>> in figure 1, the connection between UE and RNC is likely to be rerouted from being over a first Node B <<Node B 1>> to being over a second Node B <<Node B 2>> or over both <<Node B 1>> and <<Node B 2>> using soft handover. In FIG. 1, the base stations are connected to the same radio network controller RNC. However, the invention also covers the exemplary situation where the base stations are connected to different RNCs. In UMTS, the RLC protocol is terminated in a serving RNC, SRNC, responsible for interconnecting the radio access network of UMTS to a core network.

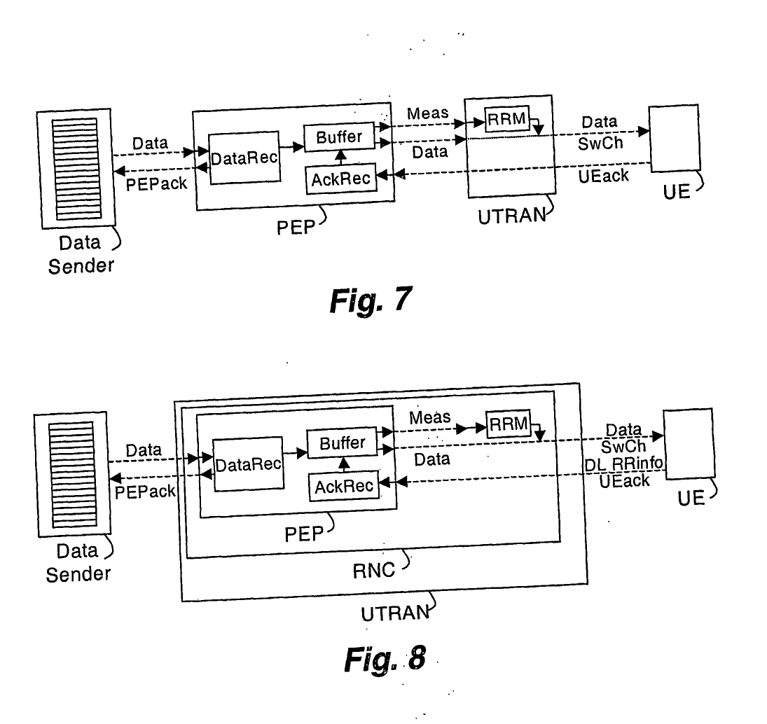

FIG. 7 shows a block diagram with a stand alone performance enhancing proxy <<PEP>> connected to a universal terrestrial radio access network <<UTRAN>>, according to the invention. A data sender <<Data Sender>> transmits data destined for a user of a user equipment <<UE>> in a communications system including an exemplary universal terrestrial radio access network <<UTRAN>> providing data for <<UE>> over a switched channel <<SwCh>>. <UE>> acknowledges received data <<UEack>>, positively or negatively. Irrespectively of the UE application protocol acknowledgements or RLC protocol acknowledgements, the proxy <<PEP>> acknowledges data received from <<Data Sender>>, positively or negatively. Data from <<Data Sender>> is received and acknowledged in a data receiver <<DataRec>> in <<PEP>>. Received data is cached or stored in a data buffer <<Buffer>> in <<PEP>>. The buffered data may be used for measurements or extraction of prediction data <<Meas>>, for radio resource management <RRM>> in UTRAN. Data is transferred from the data buffer <<Buffer>> of <<PEP>> to its destination <<UE>> on a switched channel as established by UTRAN. Acknowledgements <UEack>> of transferred data from <<UE>> are received in block <<AckRec>> of <<PEP>>. Upon acknowledgement <<Buffer>> is informed by <<AckRec>> that acknowledged data need not be stored any further for the acknowledging destination.

FIG. 8 illustrates a performance enhancing proxy <<PEP>> according to the invention integrated with radio network controller <<RNC>>, being part of <<UTRAN>> in an exemplary WCDMA system. Transmissions and devices are similar to those of FIG. 7, labeled correspondingly.

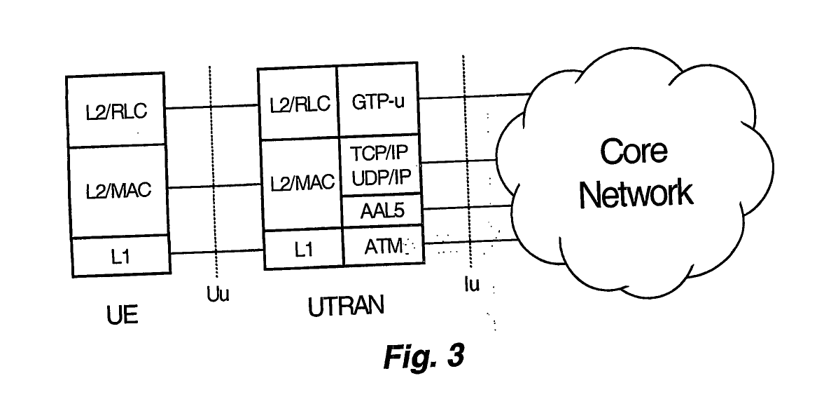

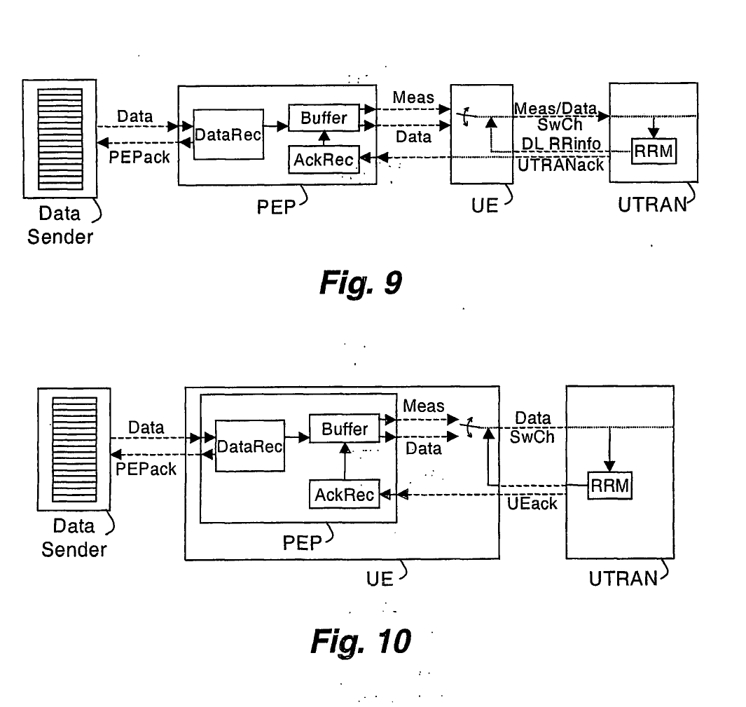

FIG. 9 shows a block diagram with a stand alone performance enhancing proxy <<PEP>> connected to a User Equipment <<UE>> according to the invention. A data sender <<Data Sender>> transmits data destined for a Server Device (not included in the figure) in a network behind an exemplary universal terrestrial radio access network <<UTRAN>>, see FIGS. 1 and 3, over a switched channel <<SwCh>>. <<UTRAN>> acknowledges received data <<UTRANack>>, positively or negatively. Irrespectively of the UE acknowledgements, the proxy <<PEP>> acknowledges data received from <<Data Sender>>, positively or negatively. Data from <<Data Sender>> is received and acknowledged in a data receiver <<DataRec>>. Received data is cached or stored in a data buffer <<Buffer>> in <<PEP>>. The buffered data may be used for measurements or extraction of prediction data <<Meas>>, for radio resource management <<RRM>> in UTRAN. Prediction data is transferred from <<UE>> to <<PEP>> on a switched channel as established. This can be identically the same channel used for payload, as well as another channel. However, for reasons of simplicity, the transfer is indicated by a separate dashed line from <<PEP>> prior to channel selection and a single dashed line from <<UE>> to <<UTRAN>>. Radio resource management data for rate and channel selection is transferred from <<UTRAN>> to <<UE>> on a downlink channel <<DL RRinfo>>. For reasons of clarity this is indicated by a separate dashed line between <<UTRAN>> and <<UE>>. However, this does not exclude that they can also be transmitted on identically the same channel. Data is transferred from the data buffer <<Buffer>> of <<PEP>> towards its destination on a switched channel <<SwCh>> as established by UTRAN. Acknowledgements <UTRANack>> of data transferred between <<UE>> and <<UTRAN>> are received in block <<AckRec>> of <<PEP>>. Upon acknowledgement, <<Buffer>> is informed by <<AckRec>> that acknowledged data need not be stored any further for the acknowledging destination.

FIG. 10 illustrates an exemplary performance enhancing proxy <<PEP>> according to the invention integrated with a User Equipment <<UE>>, preferably a user equipment of a WCDMA system. Transmissions and devices are similar to those of FIG. 9, labeled correspondingly.

The performance enhancing proxy can be physically integrated with a GTP-u tunneling protocol with the additional benefit of having a ready mapping between the RLC instances and TCP connections.

Preferably, all retransmission entities, interconnecting networks or channels of different characteristics, e.g. RNCs in UMTS, operate according to the invention for outstanding performance. However, the invention can also be used in systems also including retransmission entities, such as RNCs, not operating according to the invention.

A person skilled in the art readily understands that the receiver and transmitter properties of a BS or a UE are general in nature. The use of concepts such as BS, UE or RNC within this patent application is not intended to limit the invention only to devices associated with these acronyms. It concerns all devices operating correspondingly, or being obvious to adapt thereto by a person skilled in the art, in relation to the invention. As an explicit nonexclusive example the invention relates to mobile stations without a subscriber identity module, SIM, as well as user equipment including one or more SIMs. Further, protocols and layers are referred to in close relation with UMTS and Internet terminology. However, this does not exclude applicability of the invention in other systems with other protocols and layers of similar functionality. As a nonexclusive example, the invention applies for radio resource management interfacing of a connection protocol application layer as well as interfacing of a connection protocol transport layer, such as TCP.

The invention is not intended to be limited only to the embodiments described in detail above. Changes and modifications may be made without departing from the invention. It covers all modifications within the scope of the following claims.

1. A method of retransmission in a communications system, the method characterized in that the communications system uses switched channels, switching between rates or channels of different characteristics, and that data from a data provider is received, positively or negatively acknowledged towards the data provider and transmitted over a switched channel, and that the method allows for use of compatible protocols for non-switched and switched channels.

2. A method of retransmission in a communications system, the method characterized in that the communications system uses switched channels, switching between rates or channels of different characteristics, and that data from a data provider is received and, positively or negatively, acknowledged towards the data provider, and forwarded for transmission over a switched channel, and that the method allows for use of one or more protocols developed for non-switched channels for switched channels.

3. The method according to claim 1 or 2 characterized in that data from the data provider is cached or stored prior to being transmitted over the switched channel.

4. The method according to claim 3 characterized in that prediction on required channel resources of the switched channel is determined from cached or stored data.

5. The method according to claim 3 or 4 characterized in that data is cached or stored in association with radio resource management.

6. A method of retransmission in a communications system, the method characterized in that the communications system uses switched channels, switching between rates or channels of different characteristics, and that data from a data provider is received and, positively or negatively, acknowledged towards the data provider prior to being transmitted over the switched channel and that prediction on required channel resources of a switched channel is determined on the basis of amount of acknowledged data.

7. The method according to claim 6 characterized in that data from the data provider is cached or stored prior to being transmitted over the switched channel.

8. The method according to claim 6 or 7 characterized in that data is cached or stored in association with radio resource management.

9. The method according to any of claims 1-8 characterized in that radio resource management is provided with prediction data regarding required channel resources of a switched channel.

10. The method according to any of claims 1-9 characterized in that cached or stored data is kept in cache or storage until the transmission over the switched channel has been positively acknowledged, or that a time-out period for a negative acknowledgement has elapsed.

11. The method according to claim 4 or 9 characterized in that prediction is performed for a connection to be established.

12. The method according to claim 4 or 9 characterized in that prediction is performed for an established connection.

13. The method according to any of claims 1-12 characterized in that data is cached or stored in a performance enhancing proxy.

14. The method according to claim 13 characterized in that the performance enhancing proxy provides an interface to radio resource management.

15. The method according to claim 13 or 14 characterized in that the performance enhancing proxy is integrated with a GTP-u tunneling protocol entity.

16. The method according to any of claims 1-12 characterized in that data is cached or stored in a proxy server.

17. The method according to claim 16 characterized in that the proxy server provides an interface to radio resource management.

18. The method according to claim 16 or 17 characterized in that the proxy server is integrated with a GTP-u tunneling protocol entity.

19. The method according to any of claims 1-18 characterized in that at least one of delay and latency, as perceived by a user at the destination, is reduced.

20. The method according to any of claims 1-19 characterized in that at least one of delay and latency, as perceived by a data provider, is reduced.

21. The method according to any of claims 1-20 characterized in that at least one of delay and latency, as perceived by a congestion control algorithm at the data provider, is reduced.

22. The method according to any of claims 1-21 characterized in that utilization of switched channel resources are increased.

23. The method according to any of claims 1-22 characterized in that the differing channel characteristics includes at least one of
data rate,
dedicated or shared usage,
scheduling,
modulation,
spreading code spreading factor, and
transmission power.

24. The method according to any of claims 1-23 characterized in that the switched channel is terminated in a user equipment or a mobile station.

25. The method according to claim 24 characterized in that the switched channel is terminated in a user equipment or a mobile station of a WCDMA system or a Universal Mobile Telecommunications System.

26. The method according to claim 1-25 characterized in that data is cached in a radio network controller or in a network element connected to a radio network controller.

27. The method according to any of claims 1-23 characterized in that the switched channel is terminated in a network element.

28. The method according to claim 26 or 27 characterized in that the network element is a network element of a radio access network.

29. The method according to any of claims 26-28 characterized in that the network element is a Node B, a base station or a radio network controller or is connected to a Node B, a base station or a radio network controller.

30. The method according to any of claims 26-29 characterized in that the network element is a network element of a WCDMA system or UMTS.

31. The method according to any of claims 1-23 and 27-30 characterized in that data is cached in a user equipment or a mobile station.

32. The method according to any of claims 1-23 and 27-30 characterized in that data is cached in an entity connected to a user equipment or a mobile station.

33. The method according to any of claims 1-31 characterized in that the communications system includes a universal mobile telecommunications system or WCDMA system.

34. The method according to any of claims 1-33 characterized in that the communications system includes Internet communications.

35. An element for a communications system using channel switching, switching between rates or channels of different characteristics, the element characterized by a data receiver acknowledging, positively or negatively, received data to be transmitted over a switched channel, the element allowing for use of compatible protocols for non-switched and switched channels.

36. An element for a communications system using channel switching, switching between rates or channels of different characteristics, the element characterized by a data receiver acknowledging positively or negatively received data and forwarding the data for transmission over a switched channel, the element allowing for use of one or more protocols developed for non-switched channels for switched channels.

37. The element according to claim 35 or 36 characterized by data storage means for caching or storing of data prior to its transmission over the switched channel.

38. The element according to claim 35 or 36 characterized by data memory means for caching or storing of data prior to its transmission over the switched channel.

39. The element according to claim 37 or 38 characterized by means for communicating prediction data, based on stored or cached data, to an element responsible for radio resource management.

40. An element for a communications system using channel switching, switching between rates or channels of different characteristics, the element characterized by a data receiver acknowledging, positively or negatively, received data prior to transmission of the data over a switched channel, and means for communicating prediction data on channel resources of the switched channel, based on amount of acknowledged data.

41. The element according to claim 40 characterized by data storage means for caching or storing of data prior to its transmission over the switched channel.

42. The element according to claim 40 characterized by data memory means for caching or storing of data prior to its transmission over the switched channel.

43. The element according to any of claims 40-42 characterized by means for communicating prediction data to an element responsible for radio resource management.

44. The element according to any of claims 35-43 characterized by an acknowledgement receiver, connected to data storage or memory means.

45. The element according to any of claims 35-44 characterized in that the element keeps cached or stored data in cache or storage until the transmission of data over the switched channel has been positively acknowledged, or that a time-out period for a negative acknowledgement has elapsed.

46. The element according to any of claims 35-45 characterized by means for providing radio resource management with prediction data regarding required channel resources of a switched channel.

47. The element according to claim 39 or 46 characterized in that the prediction data concerns a connection to be established.

48. The element according to claim 39 or 46 characterized in that the prediction data concerns an established connection.

49. The element according to any of claims 35-48 characterized in that the element is a performance enhancing proxy.

50. The element according to any of claims 35-48 characterized in that the element is a proxy server.

51. The element according to any of claims 35-50 characterized in that the element reduces at least one of delay and latency, as perceived by a user at the destination.

52. The element according to any of claims 35-51 characterized in that the element reduces at least one of delay and latency, as perceived by a data provider.

53. The element according to any of claims 35-52 characterized in that the element is a network element for reducing at least one of delay and latency, as perceived by a congestion control algorithm at a data provider.

54. The element according to any of claims 35-53 characterized in that it is an element for increasing utilization of switched channel resources.

55. The element according to any of claims 35-54 characterized in that the element provides an interface to radio resource management.

56. The element according to any of claims 35-55 characterized in that the differing channel characteristics includes at least one of
data rate,
dedicated or shared usage,
scheduling,
modulation,
spreading code spreading factor, and
transmission power.

57. The element according to claim 39 characterized in that the prediction data concerns a connection to a user equipment.

58. The element according to claim 39 characterized in that the prediction data concerns a connection to a user equipment of a WCDMA system or a Universal Mobile Telecommunications System.

59. The element according to any of claims 35-58 characterized in that the element is a radio network controller or is connected to a radio network controller.

60. The element according to any of claims 35-59 characterized in that the element is integrated with a GTP-u tunneling protocol entity.

61. The element according to claim 39 characterized in that the prediction data concerns a connection to a radio access network.

62. The element according to claim 61 characterized in that the radio access network is a universal terrestrial radio access network of a WCDMA system or a Universal Mobile Telecommunications System.

63. The element according to any of claims 35-56, 61 and 62 characterized in that the element is a user equipment or is connected to a user equipment.

64. The element according to any of claims 35-63 characterized in that it is an element of a universal mobile telecommunications system or WCDMA system.

65. The element according to any of claims 35-64 characterized in that the element receives data from the Internet.

66. A radio communications system characterized by means for carrying out the method in any of claims 1-34.

67. A radio communications system characterized by a plurality of elements according to any of claims 35-65.
